(19) United States
(12) Patent Application Publication
(10) Pub. No.: US 2018/0089824 A1
(43) Pub. Date: Mar. 29, 2018

(54) METHOD OF CALIBRATING A DIRECT LASER DEPOSITION PROCESS

(71) Applicant: ROLLS-ROYCE plc, London (GB)

(72) Inventor: James H P BEVAN, Exeter (GB)

(73) Assignee: ROLLS-ROYCE plc, London (GB)

(21) Appl. No.: 15/698,833

(22) Filed: Sep. 8, 2017

(30) Foreign Application Priority Data
Sep. 27, 2016 (GB) 1616372.7

(51) Int. Cl. G06T 7/00; G06T 7/73; G06T 7/60; B33Y 50/00; B23K 26/144; B23K 26/342

(52) U.S. Cl. CPC G06T 7/0006; G06T 7/001; G06T 7/74; G06T 7/60; B22F 3/008; B23K 26/144; B23K 26/342; G06T 2207/20132; G06T 2207/30136; B33Y 50/00

(57) ABSTRACT

A method of calibrating laser alignment for a direct laser deposition machine having a powder dispensing nozzle aligned with a laser source, comprises the steps of:

(i) providing a test coupon;

(ii) firing a powder pulse at the test coupon to create a first circular imprint;

(iii) firing a laser beam pulse at the test coupon to create a second circular imprint;

(iv) aligning a first template, comprising a first outline, with the second circular imprint;

(v) positioning a second template, comprising a second outline, concentrically with the first template;

(vi) imaging the test coupon to generate a first image;

(vii) cropping the first image to the second outline to create a second image;

(viii) determining an overlap area between the first circular imprint and the second outline; and

(ix) generating an alert if the overlap area is less than a predetermined value.

### CROSS-REFERENCE TO RELATED APPLICATION

This specification is based upon and claims the benefit of priority from UK Patent Application No. GB1616372.7, filed on 27 Sep. 2016, the entire contents of which are incorporated herein by reference.

### FIELD OF THE DISCLOSURE

The present disclosure relates to a method of calibrating a direct laser deposition process and particularly, but not exclusively, to a method of calibrating laser alignment for a direct laser deposition process.

### BACKGROUND

A known technique for repairing damaged high value metallic components, for example bladed disks for turbofan gas turbine engines, involves machining away the damaged portion, rebuilding the component using a direct laser deposition (DLD) process, re-profiling the component, and then finally polishing the re-profiled surface.

The direct laser deposition process uses a nozzle which ejects metal powder in a conical shape onto a surface, and then fires a laser beam down the centre of the powder deposition nozzle, as shown in FIG. 1. Prior to deposition taking place, the nozzle and the laser beam may need to be checked for alignment and deposition size.

Conventionally, the alignment of the powder nozzle and the laser beam is checked using a so-called “Marker Pen Test”. This uses a metal coupon with a surface covered in marker pen. The coupon is then placed in the direct laser deposition machine where a programme is run. The programme fires powder out of the nozzle at various heights this removes the marker pen leaving the metal surface bare. A pulse, which simulates the full strength laser beam, is used to show the location of the laser beam spot on the surface of the coupon.

A visual inspection is then made of the coupon surface with the machine operator subjectively checking if the laser spot is aligned to the powder spot and seeing if it the nozzle is at optimum height.

The current process involves the operator subjectively checking if the laser spot is aligned to the powder spot and seeing if it the nozzle is at optimum height. This subjective process is unsatisfactory for production purposes because such checks need to be measurable, repeatable and assessed against objective criteria.

A further problem with using a human operator to check the alignment of the powder nozzle with the laser spot is that there is no clear boundary to either the laser spot or the powder spot. Consequently, such manual methods introduce errors in accuracy, reproducibility, and repeatability

### BRIEF SUMMARY

According to a first aspect of the present disclosure there is provided a method of calibrating laser alignment for a direct laser deposition machine, the machine comprising a powder dispensing nozzle and a laser source, the laser source being arranged to direct a laser beam aligned with the powder dispensing nozzle, the method comprising the steps of:
(i) providing a test coupon;
(ii) firing a powder pulse from the powder dispensing nozzle at a surface of the test coupon to create a first circular imprint;
(iii) firing a laser beam pulse at the surface of the test coupon to create a second circular imprint;
(iv) aligning a first template with the second circular imprint, the first template comprising a first outline corresponding to the area of the second circular imprint;
(v) positioning a second template concentrically with the first template, the second template comprising a second outline corresponding to the area of the first circular imprint;
(vi) imaging the surface of the test coupon to generate a first image;
(vii) cropping the first image to the second outline to create a second image;
(viii) analysing the second image to determine an overlap area, the overlap area being the proportion of the area of the first circular imprint that falls within the second outline; and
(ix) generating an alert if the overlap area is less than a predetermined value.

An advantage of the method of the present disclosure is that it can minimise human input, which reduces error and increases reliability.

The use of an image processing step to analyse the second image to determine an overlap area enables the method to be carried out without the need for human operator analysis. This makes the method of the disclosure more precise and repeatable than prior art alternatives.

The main aspect of operator input throughout the whole process is using the target on the microscope/Word to locate the centre of the pulse. The controls are very sensitive so the centre can be precisely picked. No further measuring is done by the operator meaning any associated operator error is significantly reduced. Also, by converting the image into binary, there is no speculation whether a pixel is light or dark. Every time, a consistent (exact) decision will be made by the computer.

Optionally, the first image is captured as a greyscale image.

Capturing the first image as a greyscale image will simplify the later method step of determining the overlap area common to both first circular imprint and the second outline.

Optionally, step (iv) is carried out by a human operator.

In one embodiment, the alignment of the first template with the second circular imprint is carried out by a human operator using a microscope to view the area of the test coupon comprising the powder pulse and the laser pulse.

In an alternative embodiment, a machine vision system may be used to align the first template with the second circular imprint.

Optionally, step (v) is carried out by a human operator.

In one embodiment, the positioning of the second template concentrically with the first template is carried out by a human operator using a microscope to view the area of the test coupon comprising the powder pulse and the laser pulse.

In an alternative embodiment, a machine vision system may be used to position the second template concentrically with the first template.

Optionally, step (viii) comprises the steps of:
(viii)′ overlaying a pixelated array onto the second image;
(viii)″ for each of the pixels within the second image, if the pixel includes any portion of the first circular imprint then that pixel is assigned as a black pixel, and if the pixel does not include any portion of the first circular imprint then that pixel is assigned as a white pixel; and
(viii)″’ calculating a percentage of black pixels within the second image, the percentage of black pixels being an overlap area.

By converting the greyscale image into a binary image allows the percentage of black and white pixels to be counted. This can then be correlated to the alignment of a system, focal points, and potential irregularities in flow through nozzles.

The process of counting pixels may be carried out by any suitable image processing system.

Counting pixels rather than other methods ensures higher accuracy. There is no human factor (human eye) limiting the accuracy because this has been removed. Higher quality images (with more pixels) may be used, further increasing the accuracy of the results. Using a computer increases the reliability as every repeat will produce exactly the same results.

In alternative embodiment, the image may be captured in colour with a suitable image processing system being used to assign corresponding values to pixels within the second image to thereby represent the position of the first circular imprint and thence the overlap area.

Optionally, the predetermined value is determined as the proportion of the area of the second outline that falls within the first circular imprint, when an arc portion of the first circular imprint is coincident with, and encloses, the second circular imprint.

In order for the direct laser deposition process to function correctly, the entire area of the laser spot must fall within the area of the powder pulse. In other words, the area of the second circular imprint must be wholly contained within the area of the first circular imprint. At the limit, this will be defined by the diameter of the second circular imprint being coincident with, and contained within, the first circular imprint.

According to a second aspect of the present disclosure there is provided a computer program that, when read by a computer, causes performance of the method according to the first aspect.

The image processing steps of the method lend themselves readily to automation and being co-ordinated by a computer.

According to a third aspect of the present disclosure there is provided a non-transitory computer readable storage medium comprising computer readable instructions that, when read by a computer, cause performance of the method according to the first aspect.

According to a fourth aspect of the present disclosure there is provided a signal comprising computer readable instructions that, when read by a computer, cause performance of the method according to the first aspect.

Other aspects of the disclosure provide devices, methods and systems which include and/or implement some or all of the actions described herein. The illustrative aspects of the disclosure are designed to solve one or more of the problems herein described and/or one or more other problems not discussed.

### BRIEF DESCRIPTION OF THE DRAWINGS

There now follows a description of an embodiment of the disclosure, by way of non-limiting example, with reference being made to the accompanying drawings in which:

FIG. 1 shows a schematic sectional elevational view of a direct laser deposition nozzle assembly to which the method of the disclosure may be applied, and a schematic plan view of the powder spot and laser spot combination that such a nozzle assembly will deposit on a surface;

FIG. 2 shows a schematic set of method steps illustrating a method according to an embodiment of the disclosure;

FIG. 3 shows the method step (viii)′ of overlaying a pixelated array onto the second image; and

FIG. 4 shows a schematic view of the maximum misalignment of the laser spot from the powder spot that the method of the disclosure will allow without generating a user alert.

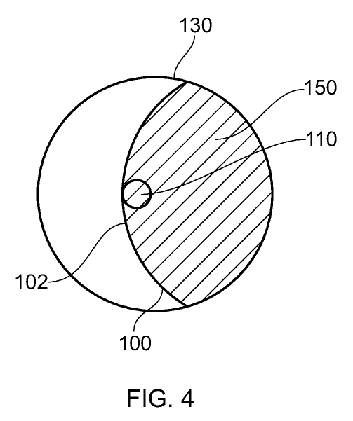

It is noted that the drawings may not be to scale. The drawings are intended to depict only typical aspects of the disclosure, and therefore should not be considered as limiting the scope of the disclosure. In the drawings, like numbering represents like elements between the drawings.

### DETAILED DESCRIPTION

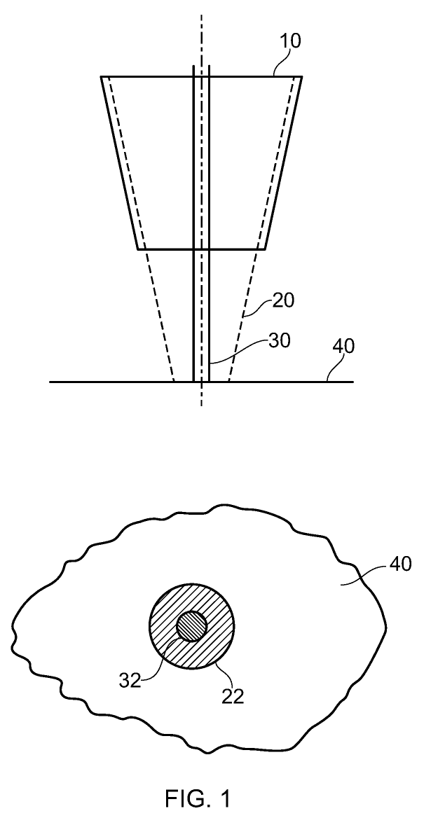

Referring to FIG. 1, a direct laser deposition nozzle assembly to which the method of the present disclosure may be applied is designated generally by the reference numeral 10.

The nozzle assembly 10 directs a powder flow 20 together with a concentrically aligned laser beam 20, onto a surface 40 onto which the powder material is to be built up. At the surface 40, the powder flow 20 deposits a circular powder spot 22 that is oriented concentrically with a laser spot 32 produced by the laser beam 30.

In the arrangement of FIG. 1, the powder flow 20 and the laser beam 30 are arranged concentrically. In other embodiments of the disclosure, the powder flow 20 and the laser beam 30 may be positioned side-by-side or in some other orientation, provided that the concentric arrangement of powder spot 22 and laser spot 32 are maintained.

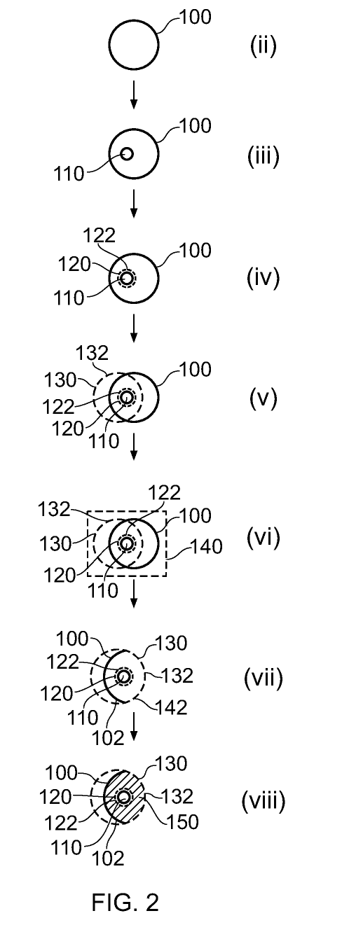

Referring to FIGS. 1 and 2, the method of the disclosure involves first providing a test coupon, shown in FIG. 1 as surface 40.

In method step (ii) a pulse from the powder flow 20 is fired at the surface 40 to generate a first circular imprint 100.

In method step (iii) a pulse from the laser beam 30 is fired at the surface 40 to generate a second circular imprint 110. If the laser beam 30 is correctly aligned with the powder flow 20 then the second circular imprint 110 will be aligned concentrically with the first circular imprint 100.

In method step (iv) the second circular imprint 110 is overlaid with a first template 120. The first template 120 comprises a first circular outline 122, the first circular outline 122 having the same diameter as the second circular imprint 110. The first template 120 is aligned concentrically with the second circular imprint 110 with the first circular outline 122 corresponding directly to the second circular imprint 110.

In method step (v) a second template 130 is positioned concentrically with the first template 120. The second template 130 comprises a second circular outline 132, the second circular outline 132 having the same diameter as the first circular imprint 100.

In method step (vi) the surface 40 of the test coupon is imaged to generate a first image 140. The first image 140 may be captured by any suitable imaging technique.

In method step (vii) the first image 140 is cropped to the second circular outline 132 to create a second image 142. The process of cropping an image to a smaller shape is a well-known image processing technique and is not discussed further herein.

In method step (viii) the second image 142 is analysed to determine an overlap area 150. The overlap area 150 is defined as the proportion of the area of the first circular imprint 100 that falls within the second circular outline 132. The analysis of method step (viii) may be performed by any suitable image processing technique.

One example of method step (viii) involves overlaying a pixelated array 160 onto the second image 142. For each of the pixels within the second image 142, if the pixel includes any portion of the first circular imprint 100 then that pixel is assigned as a black pixel 162, and if the pixel does not include any portion of the first circular imprint 100 then that pixel is assigned as a white pixel 164.

Once each of the pixels within the pixelated array 160 has been assigned as either a black pixel or a white pixel, the percentage of black pixels within the second image 142 is calculated. This percentage of black pixels represents the overlap area 150.

In method step (ix) the overlap area 150 is compared to a predetermined value and if the overlap area 150 is less than the overlap area 150 then the method generates an alert to the user.

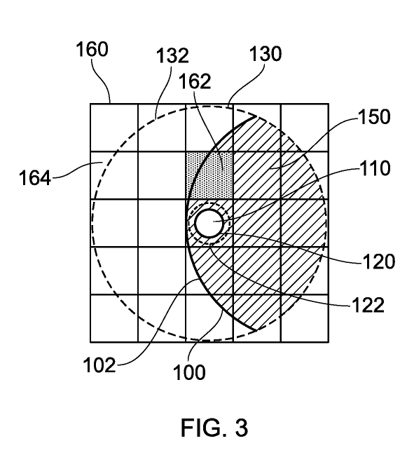

In order for the direct laser deposition process to operate correctly, the laser spot 32 must be completely contained within the powder spot 22, as illustrated in FIG. 1. Consequently, the predetermined value represents the limit state at which the laser spot 32 is at the edge of the powder spot 22. This arrangement is illustrated in FIG. 3 with the second circular imprint 110 being coincident with and enclosed by an arc portion 102 of the first circular imprint 100.

Thus the area of the first circular imprint 100 that is enclosed by the second circular outline 132 when the second circular imprint 110 is coincident with and is enclosed by an arc portion 102 of the first circular imprint 100, represents the predetermined value referred to above in method step (ix).

In an alternative arrangement, a variant of the method may be used to check the focal point of the powder nozzle. Each test ‘spot’ is captured under a microscope providing digital images of each test at different heights. The images captured are all of the same size meaning they all have the same number of pixels. The images are then run through the code which converts the images to binary and subsequently counts all the pixels and calculates the percentage of black pixels. These results can then be plotted against the height of the nozzle (they are comparable as all have same total number of pixels). Where the percentage of black pixels is at its maximum, the spot is at its smallest indicating the optimum focal point. This means less powder is required (less waste) and potentially better build quality.

In a further alternative arrangement, a variant of the method may be used to check for irregularities with the powder flow. Each spot can be captured under a microscope. These images can then be run through a similar code. This code divides the image up into quadrants, converts it from greyscale to binary and works out a percentage of black pixels. From this, you can look comparatively look at the value of each quadrant checking they all have values with the reference range. If the nozzle is not depositing properly in one area, you will be able to tell which area the how much of a reduction is taking place. It also creates a binary image of the nozzle so the operator can visually inspect the areas which are damaged/causing build irregularities.

A microscope may be used to capture an image of the ‘spots’ at different heights. Graph paper or similar could then be superposed onto the images and used to count how many squares within the ‘spot’ are light or dark—this would give quantifiable values.

This method may allow you to obtain similar data as certain methods disclosed herein. Limiting factors of this method may be:
Time taken—To accurately determine the position of the centre, very small squares need to be used. Smaller squares take longer (and are harder) to count them all.
It still has a large subjective nature in relation to if a square is light or dark—this reduces reliability and reproducibility.

Different coding software could be used to convert the image into binary and count the pixels. This would have no specific advantages, apart from the operator being more able to use the coding languages. Also, some coding languages are open source making them free to obtain a licence.

The image would not necessarily need to be split into quadrants as described—the pattern of black and white dots could be analysed in other ways, e.g. split the image into sixths, automatically assess for the “average” position of the powder stream.

Except where mutually exclusive, any of the features may be employed separately or in combination with any other features and the disclosure extends to and includes all combinations and sub-combinations of one or more features described herein.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to a person of skill in the art are included within the scope of the disclosure as defined by the accompanying claims.

1. A method of calibrating laser alignment for a direct laser deposition machine, the machine comprising a powder dispensing nozzle and a laser source, the laser source being arranged to direct a laser beam aligned with the powder dispensing nozzle, the method comprising the steps of:
(i) providing a test coupon;
(ii) firing a powder pulse from the powder dispensing nozzle at a surface of the test coupon to create a first circular imprint;
(iii) firing a laser beam pulse at the surface of the test coupon to create a second circular imprint;
(iv) aligning a first template with the second circular imprint, the first template comprising a first outline corresponding to the area of the second circular imprint;
(v) positioning a second template concentrically with the first template, the second template comprising a second outline corresponding to the area of the first circular imprint;
(vi) imaging the surface of the test coupon to generate a first image;
(vii) cropping the first image to the second outline to create a second image;
(viii) analysing the second image to determine an overlap area, the overlap area being the proportion of the area of the first circular imprint that falls within the second outline; and
(ix) generating an alert if the overlap area is less than a predetermined value.

2. The method as claimed in claim 1, wherein the first image is captured as a greyscale image.

3. The method as claimed in claim 1, wherein step (iv) is carried out by a human operator.

4. The method as claimed in claim 1, wherein step (v) is carried out by a human operator.

5. The method as claimed in claim 1, wherein step (viii) comprises the steps of:
(viii)′ overlaying a pixelated array onto the second image;
(viii)″ for each of the pixels within the second image, if the pixel includes any portion of the first circular imprint then that pixel is assigned as a black pixel, and if the pixel does not include any portion of the first circular imprint then that pixel is assigned as a white pixel; and
(viii)″’ calculating a percentage of black pixels within the second image, the percentage of black pixels being an overlap area.

6. The method as claimed in claim 1, wherein the predetermined value is determined as the proportion of the area of the second outline that falls within the first circular imprint, when an arc portion of the first circular imprint is coincident with, and encloses, the second circular imprint.

7. A computer program that, when read by a computer, causes performance of the method as claimed in claim 1.

8. A non-transitory computer readable storage medium comprising computer readable instructions that, when read by a computer, cause performance of the method as claimed in claim 1.
